(19) United States
(12) Patent Application Publication
(10) Pub. No.: US 2025/0366488 A1
(43) Pub. Date: Dec. 4, 2025

(54) Dark cocoa powders

(71) Applicant: Cargill, Incorporated, Wayzata, MN (US)

(72) Inventors: Izza Patricia Quimson Cortez, Utrecht (NL); Graciëlle Frencis Hillerie van der Kuijl-Heuvel, Purmerend (NL)

(73) Assignee: Cargill, Incorporated, Wayzata, MN (US)

(21) Appl. No.: 18/868,792

(22) PCT Filed: May 26, 2023
(86) PCT No.: PCT/US2023/023646

§ 371 Date: Nov. 25, 2024

(30) Foreign Application Priority Data
May 27, 2022 (EP) 22175776.8

(51) Int. Cl. A23G 1/00; A23G 1/30

(52) U.S. Cl. CPC A23G 1/002; A23G 1/30

(57) ABSTRACT

The present invention relates to methods of producing dark cocoa products involving steeping steps and reducing the need for alkalization, to the cocoa products obtainable or obtained by these methods, whereby the products have improved sensory profiles, in particular relating to color and taste, and to food and beverage compositions comprising them.

### CROSS-REFERENCE TO RELATED APPLICATIONS

This application claims the benefit of EP Priority application Ser. No. 22175776.8, filed May 27, 2022, which is incorporated by reference herein in its entirety.

### FIELD OF THE INVENTION

The present invention relates to methods of producing dark cocoa products with improved sensory profiles, to the cocoa products obtainable by these methods, and to food and beverage compositions comprising them.

### BACKGROUND OF THE INVENTION

Cocoa beans are a highly sought-after commodity. Processed to produce cocoa butter, cocoa mass, and cocoa powder, they are used in the manufacture of chocolate, confectionery products (including baked goods such as cookies and cakes), and beverages. Cocoa bean processing typically involves a series of well-established steps designed to enhance the sensory profiles of the final cocoa products. These include fermentation, de-hulling, and roasting of the cocoa beans. A de-hulled cocoa bean is called a cocoa nib. Nibs are crushed and/or milled to produce cocoa liquor (or “cocoa mass”) which, in turn, may be pressed to extract cocoa butter, leaving a substantially defatted cocoa cake (or “press-cake”). The cake can then be more finely ground to produce cocoa powder.

The color and flavor of cocoa powder can be further adjusted through alkalization. Typical alkalization methods are described in U.S. Pat. Nos. 4,435,436, 4,784,866 and 5,009,917, and in European Patent No. 2068641. They usually involve heating cocoa nibs in the presence of an alkalizing agent such as sodium hydroxide or potash, and result in alkalized (or “dutched”) cocoa powders with darker or more intense colors, less acidic flavors and improved water solubility when compared to their non-alkalized equivalents. These darker colors are considered highly desirable and there has therefore been a trend in the industry for more and more intense alkalization, including the production of so-called “black” cocoa powders.

Unfortunately, stronger alkalization can have a detrimental impact on flavor, producing astringent, overly bitter or chemical taste profiles. What's more, the production of black cocoa powders may require the use of undesirable chemicals (such as iron saccharate or ammonium carbonate) that create safety, environmental and regulatory risks. There has therefore been a push to develop dark cocoa powders that have improved flavor profiles and that do not rely on the use of harmful chemicals or over-alkalization.

The color of cocoa powders can be described using the Hunter color coordinate scale or CIE 1976 (CIELAB) color system which uses three coordinates (or values) to define a powder's color profile. The L coordinate represents lightness and can assume values between 0 (for black) and 100 (for white). The L value for non-alkalized cocoa powders is typically 20 or more; between 12 and 20 for slightly alkalized powders; and between 6 and 12 for highly alkalized powders. Cocoa powders described as “black” cocoa powders will typically have an L value of 6 or less.

Another method known to enhance the color of cocoa products, whether alkalized or not, includes wet processing prior to roasting. This generally involves immersing or soaking cocoa nibs in heated water, under pressure, and leads to a reduced L value in the finished product.

EP3013153 discloses a method of producing dark-red and dark-brown natural cocoa powders comprising mixing cocoa nibs with water (20% by weight relative to the weight of the nibs), heating the wetted nibs for up to 240 min, and then drying and grinding them. In one embodiment, the nibs are heated to 100° C. at atmospheric pressure. In other embodiment, they are heated to temperatures of 120-140° C. at a pressure of 3 bars. The resulting cocoa powders vary in darkness from an L value of 11.29 to an L value greater than 20 and have a pH of 5.2 to 5.6.

EP3013154 discloses a method of producing a dark-brown natural cocoa powder comprising mixing cocoa nibs with 27-35% water, heating to 89-115° C. for 30 min at pressures of 5-22 psi, and then drying and grinding the product. The resulting powders have an L value of 11.24-14.52 and a pH of 5.4-5.7.

U.S. Pat. No. 5,009,917 relates to a deep red or black dutched cocoa produced by alkalizing cocoa presscake at between 150 to 300° F., 10 to 200 p.s.i. and 5 to 180 minutes.

US 2021/0321636 A1 claims a method of producing an alkalized cocoa material, comprising the steps of: (a) mixing a cocoa material with water and an alkalizing agent; and (b) reacting the mixture of step (a) at a pressure of up to 12 bar and a temperature of 85 to 180° C., for 10 to 500 min; wherein step (b) is performed and under continuous air flow.

AU 2018200104A1 relates to a process for producing a dark brown, natural cocoa product, comprising mixing cocoa cake and water, thus producing a mixture; subjecting the mixture to an elevated pressure; and drying the mixture, thus producing a dried cocoa cake; wherein the dark brown, natural cocoa product is not alkalized.

U.S. Pat. No. 4,435,436 claims an alkalized cocoa powder that has a pH of 7.5 or less; a ratio of pH: alkalinity of the ash below 0.046; color coordinates L between 9.0 and 14.0, a between 4.0 and 8.0, and b between 2.0 and 6.0; and neither more nor other acid radicals present than those which are naturally present in fermented cocoa.

Nevertheless, there remains a need in the industry for a method of producing non-alkalized (natural) or only mildly alkalized dark cocoa powders without the use of undesirable chemicals and with improved flavor profiles.

### STATEMENTS OF THE INVENTION

In one aspect of the present invention, there is provided a process for producing a dark cocoa product, comprising the steps of: (a) wetting a cocoa material (by addition of an aqueous composition); (b) dry steeping the wetted cocoa material in the presence of oxygen; and (c) recovering a dark cocoa product.

In another aspect of the present invention, there is provided a dark cocoa product obtained by, or obtainable by, the above process. Preferably, this dark cocoa product will have an L value below 20; a ratio of a/b values greater than 1; and/or a pH below 9.0.

In another aspect of the present invention, there is provided a dark cocoa product which has:
an L value below 20;
a ratio of a/b values greater than 1; and/or
a pH below 9.0.

Such a dark cocoa product may have an ash content of less than 10% on fat-free dry matter (FFDM), preferably of less than 9% FFDM, more preferably of less than 8% FFDM. Furthermore the dark cocoa product can be a natural cocoa product.

### BRIEF DESCRIPTION OF THE FIGURES

This patent or application contains at least one drawing executed in color. Copies of this patent or patent application publication with color drawings will be provided by the Office upon request and the payment of the necessary fee. The drawings illustrate generally, by way of example, but not by way of limitation, various aspects discussed herein.

FIG. 1 shows the quantitative descriptive profiling results of the sensory analysis of Pure 2.0 A cocoa powders (cocoa powders of the present invention), as described in Example 7; where * indicates an attribute with a significant difference at p<0.1, and ** indicates an attribute with a significant difference at p<0.05.

FIG. 2 shows the quantitative descriptive profiling results of the sensory analysis of Pure 2.0 E cocoa powders (cocoa powders of the present invention), as described in Example 7; where *** indicates an attribute with a significant difference at p<0.1.

FIG. 3 shows the quantitative descriptive profiling results of the sensory analysis of Pure 2.0 I cocoa powders (cocoa powders of the present invention), as described in Example 7; where *** indicates an attribute with a significant difference at p<0.05 or p<0.01, and ** indicates an attribute with a significant difference at p<0.05.

### DETAILED DESCRIPTION

As used herein, the words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. All ranges are inclusive of their limits unless explicitly stated otherwise (thus, for instance, a range of “between A and B” is equivalent to a range of “from A to B” or of “A-B”, and includes both A and B within the recited range). It must also be noted that as used herein and in the appended claims, the singular forms “a,” “an,” and “the” include plural references unless the context clearly dictates otherwise.

The present invention relates to a process for producing a dark cocoa product. The term “cocoa product” as used herein may refer to any product derived from the cocoa bean including, in particular, cocoa nibs, cocoa liquor (or cocoa mass), cocoa cake, and cocoa powder. Preferably the cocoa product will be cocoa powder. The cocoa powder may be of any type known to the skilled person. For instance, it may be a high-fat cocoa powder, with more than 12%, typically about 20-25%, cocoa butter by weight; a standard cocoa powder, with 10-12% cocoa butter by weight; or a low-fat or fat-free cocoa powder, with less than 10% cocoa butter or less than 2% cocoa butter by weight, respectively.

The term “dark” used to describe the cocoa products of the present invention refers to the color of the cocoa product. In particular, it refers to the L value of the cocoa product as defined by the Hunter color coordinate scale or CIE 1976 (CIELAB) color system. A dark cocoa product will thus be a cocoa product with an L value that is preferably less than 20, preferably less than 18, more preferably less than 16, more preferably less than 14, more preferably less than 12, more preferably less than 10, for example between 2 and 20, preferably between 3 and 18, more preferably between 4 and 16, more preferably between 5 and 14, more preferably between 6 and 12, more preferably between 7 and 10, for instance, about 8. Advantageously, the method of the present invention can be used to produce so-called “black” cocoa products, having an L value of 6 or lower.

### Cocoa Material

The cocoa product of the present invention will be described in more detail below. It can be obtained from an initial or starting cocoa material by a method as described herein. The cocoa material may be selected from cocoa beans, cocoa nibs (whole or broken), cocoa liquor (or cocoa mass), cocoa cake, cocoa powder (including for example in agglomerated or pelletized form), and mixtures or two or more thereof. It may be (or may be derived from) cocoa beans of any type and any origin which may have undergone any one or more processing steps prior to the method of the present invention. For example, it may be (or may be derived from) cocoa beans with any degree of fermentation (including under-fermented and unfermented beans) which may have been sterilized or not and/or roasted or not. Preferably, the cocoa material will be cocoa nibs. Advantageously, the cocoa material will be a natural cocoa material. A natural cocoa material is one that has not been treated with an alkali or alkalizing agent.

The method of the present invention comprises:
wetting the cocoa material;
dry steeping the wetted cocoa material in the presence of oxygen; and
recovering a dark cocoa product.

Aqueous compositions are used in one or more of the steps in the method described herein. Any aqueous composition can be used as described below. Typical examples include water and alkali solutions. The aqueous composition can be water in one or more of the steps. The aqueous composition can be an alkali solution in one or more of the steps.

### Wetting

Wetting can be achieved using any method known to the skilled person. Wetting a cocoa material can occur by addition of an aqueous composition. For example, the cocoa material may be dunked or soaked in an aqueous composition. Alternatively, an aqueous composition may be sprayed onto or poured over the cocoa material. Any aqueous composition can be used. Typical examples include water and alkali solutions.

Alkali solutions are solutions of alkalizing salts in water. Suitable alkalizing salts include ammonium, calcium, magnesium, potassium or sodium carbonate, ammonium, potassium or sodium bicarbonate, ammonium, calcium, magnesium, potassium or sodium hydroxide, magnesium oxide or any combinations of two or more thereof. Preferred alkalizing salts include ammonium carbonate, sodium hydroxide, potassium hydroxide and mixtures of two or more thereof. Alkali solutions will typically have a concentration of alkalizing salts from 0.5% by weight to saturation, preferably from 1 to 25% by weight, more preferably from 2 to 15% by weight, more preferably from 3 to 10% by weight, relative to the total weight of the alkali solution. For example, an alkali solution of 4-9% by weight or of 5-8% may be used, such as an alkali solution of about 6-7% by weight. Advantageously, it has been found that the amount of alkali needed to achieve a certain level of darkness in the final cocoa product is less when using the method of the present invention compared to other methods known in the art. Even more advantageously, it had been found that alkalization can be avoided entirely. As such, the method of the present invention will preferably not include an alkalization step. As such, the cocoa material will preferably not be wetted with an alkali solution. Instead, it will preferably be wetted with water.

The wetted cocoa material will preferably have a moisture content of 10-60%, more preferably 15-50%, more preferably 20-40% by weight. Wetting may comprise pouring an aqueous composition over the cocoa material until it appears fully wetted (i.e., no visible dry patches), or briefly dunking the material in an aqueous composition, and allowing any excess aqueous composition (that is aqueous composition than has not been absorbed by the cocoa material) to drain off or otherwise be removed.

The aqueous composition used to wet the cocoa material will preferably be pre-heated to a temperature between 30 and 120° C., more preferably to a temperature between 40 and 110° C., more preferably to a temperature between 50 and 100° C., more preferably to a temperature between 60 and 90° C., for instance about 70° C.

### Dry Steeping

After the wetting step, the process of the present invention comprises a dry steeping step. The dry steeping step will preferably be performed immediately after the wetting step, that is, without any intermediate steps. Dry steeping involves treating wetted cocoa material. The wetted cocoa material preferably does not include excess aqueous composition and/or aqueous composition that is unabsorbed by the cocoa material. The wetted cocoa material in the dry steeping is preferably not immersed or soaked in an aqueous composition. Preferably, excess aqueous composition has been drained off or otherwise removed from the cocoa material prior to initiating the dry steeping step.

Dry steeping involves holding the wetted cocoa material under predefined conditions for a certain period of time. Preferably, it will involve holding the wetted cocoa material at an elevated temperature, under conditions of high humidity. More preferably, the dry steeping step does not involve the addition of alkali or alkali solutions that would increase the alkalinity of the cocoa material. The dry steeping step may last for 1 hour to 7 days. Preferably, it will last for 12 hours to 7 days, more preferably for 12 hours to 6 days, more preferably for 24 hours to 7 days, more preferably for 24 hours to 6 days, more preferably for 2 to 7 days, more preferably for 2 to 6 days, more preferably for 3 to 7 days, more preferably for 3 to 6days, more preferably for 4 to 7 days, more preferably for 4 to 6 days, more preferably about 5 days.

The elevated temperature of the dry steeping step is preferably a temperature between 30 and 120° C., more preferably between 40 and 110° C., more preferably between 50 and 100° C., more preferably between 60 and 90° C., more preferably between 60 and 80° C., more preferably between 70 and 80° C., for instance about 75° C. If necessary, the wetted cocoa material may be heated during the dry steeping step to achieve and/or to maintain the desired temperature. Heating can be achieved using any means known in the art, such as a performing the steeping step in a heated tank or vessel or in an oven.

The term “high humidity” as used herein in relation to the dry steeping step refers to levels of relative humidity sufficient to maintain the moisture content of the cocoa material after wetting, that is to maintain a moisture content for the cocoa material of 10-60%, more preferably 15-50%, more preferably 20-40% by weight, relative to the total weight of the cocoa material. Preferably, the relative humidity during the dry steeping step will be 50% or more, more preferably 50-100%, more preferably 60-100%, more preferably 70-100%, more preferably 80-100%, more preferably 90-100%.

If necessary, the target moisture content of the cocoa material (as defined above) may also be maintained during the dry steeping step by adding a further aqueous composition (as defined above). Preferably, the target moisture content of the cocoa material during dry steeping is maintained by adding a further aqueous composition comprising water. More preferably, the target moisture content of the cocoa material during dry steeping is maintained without the addition of an alkali solution. By way of illustration, further aqueous composition may be added in a single step, at predefined intervals, when a certain minimum moisture content is reached, or continuously throughout the dry steeping step.

### Contact With Oxygen

During the dry steeping step, the cocoa material is contacted with oxygen. This can be achieved using any method known in the art. For example, the dry steeping step may be performed—for at least part of its duration, but preferably for its full duration—in an oxygen-rich atmosphere such as air, oxygen-enriched air, ozone, or pure oxygen. This can be achieved by performing at least part of the dry steeping step such that the wetted cocoa material is exposed to ambient air and is not fully enclosed within a sealed tank, vessel or oven.

Alternatively (or in addition), contact with oxygen may be achieved with an oxygenation step. Oxygenation may be achieved by any method known in the art including, for example, by introducing a flow of oxygen-rich gas (such as air, oxygen-enriched air, ozone, or pure oxygen) into the tank, vessel or oven used for the dry steeping step.

If using a flow of oxygen-rich gas, the gas flow may be continuous or intermittent. Advantageously, the oxygen-rich gas will be pumped into the steep tank or vessel, or oven, in such a way as to come into contact with the wetted cocoa material in a uniform manner. This may be achieved, for instance, by placing the cocoa material on a slotted or perforated tray, or any other surface that is gas-permeable such as a mesh or grill, and pumping the oxygen-rich gas into the tank, vessel or oven.

The cocoa material will preferably be in continuous or substantially continuous contact with the oxygen-rich gas throughout the dry steeping step, or for a substantial portion thereof. It may also be brought into contact with an oxygen-rich gas during other stages of the present method, for example during the wetting step or during the optional wet steeping step described below. The flow rate through the reactor will preferably be 0.1-20 m/s, preferably 1-19 m/s, more preferably 5-18 m/s, more preferably 7-17 m/s, more preferably 9-16 m/s. “m/s” represents meters per second. Preferably, the oxygen-rich gas will be air. Accordingly, the dry steeping step may be performed in an oven through which there is a continuous flow of air.

To maximize contact with oxygen, whether performing the dry steeping step in an oxygen-rich atmosphere or with the addition of an oxygen-rich gas flow, the cocoa material will preferably be spread out (or allowed to spread out) into a thin layer. By way of example only, if the cocoa material comprises cocoa beans or cocoa nibs, these will preferably be spread out into a single layer during the dry steep step.

Alternatively or additionally, oxygenation can be achieved by contacting the wetted cocoa material with an oxidizing agent. Oxidizing agents may be added to the aqueous composition used to wet the cocoa material, and/or they may be added to the wetted cocoa material itself. Oxidizing agents may be selected from any one or more oxidizing agents known in the art. These include, by way of example only, hydrogen peroxide and ozone. Preferably the oxidizing agent will be hydrogen peroxide. If used, hydrogen peroxide will preferably be added in an amount of 0.1 to 1% by weight, based on the total weight of the aqueous composition.

Whichever method is used, the cocoa material will preferably be in contact with oxygen for sufficient time to permit the target color to develop. Thus, according to one aspect of the present invention, there is provided a method for producing a dark cocoa product comprising wetting a cocoa material and contacting the wetted cocoa material with oxygen during a dry steeping step.

### Wet Steeping

The dry steeping may be preceded and/or followed by a wet steeping step. “Wet steeping” as used in the context of the present invention refers to the process of immersing or soaking the cocoa material in an aqueous composition (as defined above) for an extended period of time, preferably for a time sufficient for the cocoa material to become substantially fully wetted. A cocoa material will be “substantially fully wetted” when it has been substantially fully impregnated with an aqueous composition (as opposed, for example, to being only superficially wetted). By “substantially fully wetted”, it is meant that when the cocoa material is in the form of cocoa beans or cocoa nibs, the aqueous composition used to wet them will preferably have penetrated at least 20% of the distance to the core of the bean or nib from the surface, more preferably to at least 50% of the distance to the core of the bean or nib from the surface, more preferably to between 60% of the distance to the core from the surface and to the core of the bean or nib. Thus, for example, when the cocoa material is in the form of cocoa beans or cocoa nibs, the aqueous composition used to wet them will more preferably have penetrated to the core of the bean or nib.

In the context of wet steeping, the mixture of cocoa material and aqueous composition will be referred to as a steep mixture, and the equipment used to perform the steeping step will be referred to as a steep tank.

Advantageously, during any wet steeping step(s), the cocoa material will be immersed in sufficient aqueous composition to fully cover it. Alternatively, or in addition, the cocoa material may be agitated during the wet steeping process, for example by manual or mechanical stirring of the steep mixture or by agitation or shaking of the steep tank itself.

Any wet steeping step(s) can (each) last for up to 5 hours. Typically, they will last for 15 min to 5 hours, preferably for 30 min to 4 hours, more preferably for 30 min to 3 hours. They will advantageously be performed at an elevated temperature. For example, any wet steeping step(s) will preferably be performed at temperatures of 80-150° C., more preferably of 90-140° C., more preferably of 100-130° C. Heating can be achieved using any means known in the art, such as a performing the steeping step in a heated steep tank and/or by preheating the aqueous composition before it is added to the cocoa material.

Any wet steeping step(s) will preferably be performed at atmospheric or higher than atmospheric pressures. For example, they may be performed at pressures of 1 to 3 bars. Without wishing to be bound by theory, it is believed that these elevated temperatures and/or pressures promote faster absorption of water into the cocoa material and make the wet steeping process more efficient, allowing shorter wet steeping times to be used.

The wet steeping step(s) may also bring the cocoa material into contact with oxygen, either by being performed in an oxygen-rich atmosphere or through oxygenation (introduction of an oxygen-rich gas flow or addition of an oxidizing agent), all as described above. Preferably, contact with oxygen during any wet steeping step(s) will be achieved by introducing an oxygen-rich gas into the steep mixture, for instance by pumping an oxygen-rich gas (such as air) into a lower portion of the steep tank (below the cocoa material) and allowing it to bubble up through the cocoa material. One way of doing this would be through the use of a fluidized-bed reactor but the skilled person will be familiar with other suitable means. If used, the airflow of oxygen-rich gas through the reactor during the wet steeping step(s), will preferably be 1000 to 10.000 ml/min/kg, more preferably 1000 to 5000 ml/min/kg, more preferably 1000 to 4000 ml/min/kg, more preferably 1000 to 3000 ml/min/kg, more preferably 1000 to 2000 ml/min/kg of cocoa material.

If a wet steeping step precedes the dry steeping step, any excess aqueous composition remaining at the end of the wet steeping step will be removed, leaving a wetted cocoa material. No additional wetting will be necessary prior to starting the dry steeping step. In this case, the wet steeping step will replace the wetting step described above. Thus, the present invention advantageously provides a process for producing a dark cocoa product comprising (a) wetting a cocoa material during a wet steeping step, and (b) allowing the wetted cocoa material to steep in the presence of oxygen, preferably in a dry steeping step.

If a wet steeping step follows the dry steeping step, once dry steeping has been completed, further aqueous composition (either the same or different to the aqueous composition used to initially wet the cocoa material) will be added to the cocoa material to initiate a wet steeping step as described above. At the end of the wet steeping step, any remaining excess aqueous composition (that is aqueous composition that has not been absorbed by the cocoa material), will be removed, e.g., by draining. In this case, the present invention provides a process for producing a dark cocoa product comprising (a) wetting a cocoa material, (b) performing a dry steeping step, and (c) performing a wet steeping step.

If a wet steeping step is included both before and after the dry steeping step, the process of the present invention would include the following steps: (a) a first wet steeping step, (b) a dry steeping step, and (c) a second wet steeping step.

The processing of cocoa materials described herein includes a wetting step comprising addition of an aqueous composition to the cocoa material. The aqueous composition can be water or an alkali composition. An alkali solution of 4-9% by weight, preferably 5-8% by weight, more preferably 6-7% by weight may be used for wetting the cocoa material. The wetted cocoa material will preferably have a moisture content of 10-60%, more preferably 15-50%, more preferably 20-40% by weight. The aqueous composition used to wet the cocoa material will preferably be pre-heated to a temperature between 50 and 100° C., more preferably to a temperature between 60 and 90° C., for instance about 70° C.

The processing of cocoa materials described herein also includes a dry steeping step. The dry steeping step is conducted under high humidity while maintaining the moisture content of the wetted cocoa material, at an elevated temperature for a duration of time in contact with oxygen. The dry steeping step may last for 12 hours to 6 days, more preferably for 24 hours to 6 days, more preferably for 2 to 6 days, more preferably for 3 to 6 days, more preferably for 4 to 6 days, more preferably about 5 days. The elevated temperature of the dry steeping step is preferably a temperature between 50 and 100° C., more preferably between 60 and 90° C., more preferably between 70 and 80° C., for instance about 75° C. The moisture content for the cocoa material is preferably maintained at 20-40% by weight, more preferably 20-40% by weight, relative to the total weight of the cocoa material. Preferably, the relative humidity during the dry steeping step will be 50-100%, more preferably 60-100%, more preferably 70-100%, more preferably 80-100%, more preferably 90-100%. The flow rate of the oxygen rich gas through the reactor will preferably be 0.1-20 m/s, preferably 1-19 m/s, more preferably 5-18 m/s, more preferably 7-17 m/s, more preferably 9-16 m/s. Preferably, the oxygen-rich gas will be air. Accordingly, the dry steeping step may be performed in an oven through which there is a continuous flow of air.

Wet steeping, if used, can last for up to 5 hours, preferably between 30 min. and 3 hours. We steeping will be preferably be performed at temperatures of 80-150° C., or more preferably at 100-130° C. Wet steeping will be performed with a pressure between about 1-3 bars. If used, the airflow of oxygen-rich gas through the reactor during the wet steeping step(s), will preferably be 1000 to 10.000 ml/min/kg, more preferably 1000 to 5000 ml/min/kg, more preferably 1000 to 4000 ml/min/kg, more preferably 1000 to 3000 ml/min/kg, more preferably 1000 to 2000 ml/min/kg of cocoa material.

After completion of the one or more steeping steps, and removal of any residual excess aqueous composition, a dark cocoa product may be recovered. Alternatively, the wetted cocoa material may be subjected to one or more further processing steps.

### Further Processing

Optional further processing steps include drying and/or milling the cocoa material.

Preferably, after completion of the steeping step(s), the cocoa material is dried. During drying, the moisture content of the cocoa material is preferably reduced to 10% or less, more preferably to 8% or less, more preferably to 7% or less, more preferably to 5% or less, more preferably to 3% or less, more preferably to 2% or less, more preferably to 1% or less.

Drying can be achieved using any technique known in the art. This may include simple air drying at ambient temperature, drying at elevated temperatures, for example at temperatures above 105° C., and/or roasting. Preferably, the cocoa material will be roasted, advantageously at temperatures in the range of 90-150° C., more advantageously of 100-140° C., more advantageously of 110-130° C. If used, roasting will typically last for 50 to 150 minutes, preferably 90 to 120 minutes.

The cocoa material may also be milled and/or ground. For instance, it may be subjected to one or more milling and/or grinding steps to reduce its particle size. Advantageously, the cocoa material will be milled and/or ground to a particle size of less than 100 μm, more preferably to less than 50 μm, more preferably to less than 40 μm. For example, the cocoa material may be milled to 20-40 μm.

Other possible processing steps will be well known to a person skilled in the art, and will readily be adapted depending on the nature of the starting cocoa material and the desired end product. For instance, if the cocoa material comprises cocoa beans/and or cocoa nibs and the desired end product is a cocoa powder, the process of the present invention may also comprise a pressing step (to separate cocoa solids from cocoa butter) and one or more optional milling/grinding steps (to further reduce the particle size of the cocoa solids).

Preferably, cocoa nibs will be used as the starting material for the method of the present invention. They will be wetted and dry steeped, as described above. Advantageously, the resulting cocoa material will then be subjected to a roasting step and one or more grinding or milling steps (including at least one fine grinding step) and a pressing step (to remove cocoa butter) to produce a cocoa powder. Thus, for example, the method of the present invention may include the following steps:
wetting a cocoa material such as cocoa nibs, optionally by wet steeping step the cocoa material in a first aqueous composition,
dry steeping the wetted cocoa material in the presence of oxygen,
optionally wet steeping the dry steeped cocoa material in a second aqueous composition,
optionally drying and/or roasting the steeped cocoa material,
optionally milling/grinding the dry cocoa material,
optionally pressing the milled/ground cocoa material to remove cocoa butter,
optionally fine grinding the remaining cocoa solids, and
recovering a dark cocoa product, preferably a dark cocoa powder,
wherein the first and second aqueous compositions may be the same or different.

Advantageously, dark cocoa products may be recovered from the process of the present invention, even without the use of alkalizing agents. Accordingly, the process of the present invention will preferably not include an alkalization step (whether separately from or as part of any of the above-recited steps), or the addition or use of any alkalizing agents.

### Dark Cocoa Products

The present invention also provides dark cocoa products obtained by, or obtainable by, a process as described herein. Cocoa products of the present invention will advantageously have a desirable color profile. The color of cocoa powders can be expressed using the Hunter color coordinate scale or CIE 1976 (CIELAB) color system which uses three coordinates (or values) to define a powder's color profile. The L coordinate represents lightness and can assume values between 0 (for black) and 100 (for white); the a value represents the red/green component (a>0); and the b value represents the yellow/blue component (b>0). The quotient of “a” over “b” represents the redness of the product. Further information on the CIELAB color system can be found, for example, in “Defining and Communicating Color: The CIELAB System” (2013—Sappi Fine Paper North America) and an example of how to measure the “L”, “a” and “b” values is described under Methodology below.

Cocoa products obtainable by the method of the present invention advantageously have a darker color than the corresponding starting cocoa material. Preferably, they will also have a darker color than a cocoa product obtained from the same starting material but without the combination of wetting and oxygen-contact step(s) of the present method. For example, cocoa products obtained by the method of the present invention will be darker than cocoa products obtained from the same starting material and processed in the same way except for the omission of the combined wetting and oxygen-contact steps.

As used herein, the term “darker” refers to a product having a lower L value than the product to which it is being compared. Preferably, the darker product will have an L value at least 1 point lower, even more preferably at least 2 points lower, than the product to which it is being compared. Advantageously, cocoa products obtainable by the method of the present invention will be “dark” cocoa products, that is cocoa products with an L value of less than 20, preferably less than 18, more preferably less than 16, more preferably less than 14, more preferably less than 12, more preferably less than 10, for example between 4 and 20, preferably between 5 and 18, more preferably between 6 and 16, more preferably between 8 and 14, such as 8-13 or 8-12 or 8-11 or 8-10.

Advantageously, cocoa products obtainable by the method of the present invention will have a reddish color, with their “a” values typically greater than their “b” values (i.e., a ratio of a/b of greater than 1).

Preferably, the “a” value of the cocoa products obtainable according to the method of the present invention will be in the range of 1.0 to 12.0, preferably 2.0 to 11.0, more preferably 3.0 to 10.0. For example, powders obtainable according to the present invention, with L values below 10, will typically have an “a” value of 3.0 to 6.0, preferably of 4.0 to 5.0; and powders with L values from 10 to 18 will typically have an “a” value of 8.0 to 10.0, preferably of 8.5 to 9.5.

The “b” value of the cocoa products obtainable according to the method of the present invention will preferably be in the range of 1.0 to 10, more preferably 2.0 to 9.0, more preferably 3.0 to 8.0. For example, powders obtainable according to the present invention, with L values below 10, will typically have a “b” value of 1.0 to 5.0, preferably of 2.0 to 4.0; and powders with L values from 10 to 18 will typically have a “b” value of 5.0 to 9.0, preferably of 6.0 to 8.0.

Normally, to produce dark cocoa powders like those of the present invention, the degree of alkalization required results in a high pH and an undesirable, alkaline flavor profile. Advantageously, with the method of the present invention, it is possible to produce dark cocoa powders with much lower alkalinity (since no or only mild alkalization is required) and therefore with improved flavor relative to alkalized cocoa powders of equivalent darkness. Thus, the cocoa products of the present invention will advantageously have a pH that is lower than a corresponding product made from the same starting material and with the same L value but obtained by traditional alkalization techniques. The cocoa products of the present invention preferably have a pH of 9.0 or less, more preferably of 8.0 or less, more preferably of 7.0 or less, more preferably of 6.0 or less, for example between 3.0 and 9.0, preferably between 3.0 and 8.0, more preferably between 3.0 and 7.0, more preferably between 4.0 and 6.0, for example between 4.5 and 6.0 or between 4.5 and 5.5. This results in improved taste relative to highly alkalized cocoa products.

The present invention also provides cocoa products, such as cocoa powders, which have an ash content of less than 10% on fat-free dry matter (FFDM), preferably of less than 9% FFDM, more preferably of less than 8% FFDM, most preferably less than 7.5% FFDM.

In one aspect, the present invention therefore provides cocoa products, such as cocoa powders, which have an L value of less than 20; a ratio of a/b greater than 1, and a pH of less than 9.0., and optionally an ash content of less than 10% FFDM. Advantageously, the cocoa products of the present invention are natural cocoa products. A natural cocoa product is one that has not be treated with alkali or alkalizing agents. Thus, the present invention preferably provides natural cocoa products which have an L value of less than 20; a ratio of a/b greater than 1, and a pH of less than 9.0, and optionally an ash content of less than 10% on FFDM.

### Sensory Profile

As used herein, “taste” refers to sensory perception on the tongue. For example, the 5 basic tastes are sweet, sour, salty, bitter, and umami. As used herein, “aroma” refers to the orthonasal perception in the nasal cavity. As used herein, “flavor” refers to the taste and retronasal perception in the nasal cavity. As used herein, “off-taste(s)” refer to a taste or flavor attribute profile that is not characteristic or usually associated with a substance or composition as described herein and/or a characteristic taste or flavor associated with a substance or composition that is undesirable. For example, the off-taste may be an undesirable taste such as bitterness, undesirable mouthfeel such as astringency, mouth drying, undesirable flavor such as rancid, cardboard, aftertaste, inconsistent flavor (e.g., a flavor with an uneven onset or intensity, a flavor that may be perceived too early or too late), and the like.

A further advantage of the present invention is that the cocoa products will have a desirable flavor profile. In particular, they have (i) a less astringent/alkali flavor than alkalized cocoa products with similar color profiles (for instance with the same L value); and or (ii) a more chocolatey or more intense cocoa flavor than other dark cocoa products, including other dark, natural cocoa products. These flavor attributes can be objectively assessed using sensory panels.

Sensory panels are a scientific and reproducible method that is essential to the food and beverage industry. A sensory panel involves a group of two or more individual panelists. Panelists are instructed according to industry-recognized practices to avoid the influence of personal subjectivity and strengthen reproducibility. For example, panelists may objectively evaluate sensory attributes of a tested product but may not provide subjective attributes such as personal preference.

In various aspects, the sensory panel can be conducted with two, three, four, five, six, or more panelists, in which the panelists identify and agree on a lexicon of sensory attributes for a given set of samples. After evaluating a specific sample, the panelists can assign a numerical intensity score for each attribute using an intensity scale. For example, intensity scales can range from 0 to 6 (i.e., 0=not detected, 1=trace, 2=slight, 3=moderate, 4=definite, 5=strong, 6=extreme), 0 to 9 (i.e., 0=not detected, 1=trace, 2=faint, 3=slight, 4=mild, 5=moderate, 6=definite, 7=strong, 8=very strong, 9=extreme), or 0 to 100 where 0 corresponds to the absence of the attribute, while 100 corresponds to the upper bound extreme occurrence of the attribute. The panel may use a roundtable consensus approach, or the panelists may score and evaluate the sensory attribute(s) individually. Either format can further involve a panel leader who directs the discussion regarding terminology and directs the panel to evaluate particular products and attributes. In other aspects, a trained sensory panel can be utilized to assess specific attributes using descriptive analysis or time intensity methodologies.

As used herein, “panelist” refers to a highly trained expert taster, such as those commonly used for sensory methodologies such as descriptive analysis, and/or an experienced taster familiar with the sensory attribute(s) being tested. In some aspects, the panelist may be a trained panelist. A trained panelist has undergone training to understand the terms and sensory phenomenon associated with those sensory attributes relevant to the tested product and are aligned on the use of common descriptors for those sensory attributes of interest (i.e., a sensory lexicon). For example, a trained panelist testing a given composition will understand the terms and sensory attributes associated with said composition, e.g. saltiness, sourness, bitterness, astringency, mouthfeel, acidity, and the like. The trained panelist will have been trained against reference samples corresponding to the sensory attributes being tested and thus have calibrated to recognize and quantitatively assess such criteria. In some aspects, the panelist may be an experienced taster.

If the samples are scored and evaluated by panelists independently, the panelists will first agree upon or be instructed in a lexicon of sensory attributes and intensity scores. Panelists may evaluate samples in replicate and may be blinded to the samples they are testing. Samples being tested may be provided to the panelists randomly or in a sequential order. For instance, samples may be tested by panelists using a randomized balanced sequential order. Scores from individual panelists are then assessed using standard statistical analysis methods to determine an average sensory intensity score. One of skill in the art will recognize the appropriate lexicon and reference or standard samples necessary for sensory assessment of a given sample(s) as well as the appropriate statistical analysis methods.

As used herein, “randomized balanced sequential order” refers to the order in which samples are presented in which the order is randomized but across all panelists all possible orders of the samples will be presented to remove bias for the samples being tested in a particular order. For example, for a randomized balanced sequential order of two samples, there would be an equal likelihood that a given panelist receives sample 1 before sample 2 and sample 2 before sample 1. In an example with three samples (i.e., samples 1, 2, and 3), a randomized balanced sequential order would include an equal likelihood that panelists receiving samples in the following orders: (i) 1, 2, 3; (ii) 1, 3, 2; (iii) 2, 1, 3; (iv) 2, 3, 1; (v) 3, 2, 1; (vi) 3, 1, 2.

Conventional complementary ingredients can be included with the samples to be tested if desired. For example, a cocoa powder sample may be mixed with sweetening agents such as natural sweeteners (including, for example, sugars such as sucrose, sugar alcohols such as xylitol, sorbitol, erythritol), artificial sweeteners (such as, for example, saccharin and aspartame, sodium cyclamate, and mixtures of sodium cyclamate and saccharin). Other examples include acesulfame-k, alitame, and sucralose. Mixtures can be used. Milk powders also can be used (including full-fat, semi-skimmed or fat-free milk powders). Other examples of complementary ingredients include vitamins, trehalose, colors, flavors, and bulking agents. The powder mixtures may then be dissolved in a solvent such as water or milk. Complementary ingredients can be selected to be compatible with the solvent.

### Food and Beverage Compositions

The cocoa products of the present invention, or obtained according to the method of the present invention, can be used on their own or mixed with other cocoa products to produce food and beverage compositions with tailored color and flavor profiles. Advantageously, they can also be used to decrease costs, since smaller quantities can be used to achieve the same color impact as larger quantities of standard cocoa products. Thus, the present invention also provides food and beverage compositions comprising a cocoa product, or obtainable by a method, as described herein. These may include, by way of illustration only, milk, dark, and white chocolate and compound compositions (for use, amongst others, in confectionary, as bars, in truffles and pralines, or as inclusions, coatings, or fillings), drinking chocolate, flavored milks (dairy and non-dairy), flavored syrups, bakery products (such as cakes, cookies and pies), diet bars and meal substitutes, sports and infant nutrition, ice-cream products, dairy products, puddings, mousses, sauces, and breakfast cereals. Methods of manufacturing these food and beverage compositions are also part of the present invention.

The invention is also covered by the following clauses:

Clause 1. A process for producing a dark cocoa product, comprising the steps of:
a. wetting a cocoa material;
b. dry steeping the wetted cocoa material in the presence of oxygen, preferably wherein the dry steeping does not include the addition of alkali or an alkali solution; and
c. recovering a dark cocoa product.

Clause 2. A process according to clause 1 wherein the cocoa material of step (a) is selected from cocoa beans, cocoa nibs, cocoa liquor, cocoa cake, cocoa powder, and mixtures of any two or more thereof.

Clause 3. A process according to clause 1 or clause 2, wherein the dry steeping step:
is performed in an oxygen-rich atmosphere; and/or
includes oxygenating the wetted cocoa material of step (a).

Clause 4. A process according to clause 3, wherein oxygenating the wetted cocoa material comprises:
contacting the wetted cocoa material with an oxygen-rich gas flow; and/or
contacting the wetted cocoa material with an oxidizing agent.

Clause 5. A process according to any one of the preceding clauses, wherein the dry steeping step is performed at a temperature of between 30 and 120° C.

Clause 6. A process according to any one of the preceding clauses, wherein the dry steeping step is performed at a relative humidity above 50%.

Clause 7. A process according to any one of the preceding clauses, wherein the wetted cocoa material has a moisture content of 10-60% by weight.

Clause 8. A process according to any one of the preceding clauses, wherein the moisture content of the wetted cocoa material is maintained during step (b).

Clause 9. A process according to any one of the preceding clauses, wherein dry steeping the wetted cocoa material in step (b) comprises holding the wetted cocoa material at an elevated temperature for at least 12 hours or at least 24 hours or at least 24 hours to 6 days.

Clause 10. A process according to any one of the preceding clauses, further comprising one or more wet steeping steps.

Clause 11. A process according to any one of the preceding clauses, wherein step (a) comprises wet steeping the cocoa material.

Clause 12. A process according to any one of the preceding clauses, where step (c) comprises drying and optionally milling the dry steeped cocoa material.

Clause 13. A process according to any one of the preceding clauses wherein the dark cocoa product recovered from step (c) has an L value below 20.

Clause 14. A process according to any one of the preceding clauses wherein the dark cocoa product recovered from step (c) has a ratio of a/b values greater than 1.

Clause 15. A process according to any one of the preceding clauses wherein the dark cocoa product recovered from step (c) has a pH below 9.0.

Clause 16. A process according to any one of the preceding clauses wherein the dark cocoa product recovered from step (c) has an ash content of less than 10% on fat-free dry matter (FFDM).

Clause 17. A dark cocoa product obtained by, or obtainable by, the process of any one of the preceding clauses.

Clause 18. A dark cocoa product according to clause 17 which has:
an L value below 20; and/or
a ratio of a/b values greater than 1; and/or
a pH below 9.0.

Clause 19. A dark cocoa product according to clause 17 or 18 having an ash content of less than 10% on fat-free dry matter (FFDM).

Clause 20. A dark cocoa product according to clause 17 or 18 having an ash content of less than 9% FFDM.

Clause 21. A dark cocoa product according to clause 17 or 18 having an ash content of less than 8% FFDM.

Clause 22. A dark cocoa product according to any one of clauses 17 to 21, which is a natural cocoa product.

Clause 23. A dark cocoa product which has:
an L value below 20; and/or
a ratio of a/b values greater than 1; and/or
a pH below 9.0.

Clause 24. A dark cocoa product according to clause 23 having an ash content of less than 10% on fat-free dry matter (FFDM).

Clause 25. A dark cocoa product according to clause 23 having an ash content of less than
9% FFDM.

Clause 26. A dark cocoa product according to clause 23 having an ash content of less than
8% FFDM.

Clause 27. A dark cocoa product according to any one of clauses 23 to 26, which is a natural cocoa product.

Clause 28. A food or beverage comprising the dark cocoa product obtainable from any one of clauses 1 to 16.

Clause 29. A food or beverage composition comprising the dark cocoa product according to any one of clauses 17 to 27. The food or beverage composition can be milk, dark, and white chocolate and compound compositions (for use, amongst others, in confectionary, as bars, in truffles and pralines, or as inclusions, coatings, or fillings), drinking chocolate, flavored milks (dairy and non-dairy), flavored syrups, bakery products (such as cakes, cookies and pies), diet bars and meal substitutes, sports and infant nutrition, ice-cream products, dairy products, puddings, mousses, sauces, and breakfast cereals.

Various embodiment of the present invention will now be described by way of the following examples which are provided for illustration purposes only and are not intended to be limiting.

### EXAMPLES

### Colour Measurement Method

All color values measured in the below examples were measured according to the following methodology.

### Instruments and Reagent

Balance correct up to 0.01 gram
100 ml beaker
Stirring rod
Measuring cylinder (25 ml)
Optically neutral petridish (Brand: Sterilin)
Spectrocolorimeter Hunterlab Colorquest, use Illuminant C and 2° standard observer, read values in Hunter L, -a and b values.
Calibration tile black, as present with instrument
Calibration tile white, as present with instrument
Reference cocoa powder sample with known color values
Tap water, temperature range 50-60° C.
Thermometer

### Calibration Procedure

Calibration was done using the black and white calibration tiles provided with the Hunterlab color meter, following manufacturer's instructions.

### Color Measurement Method

5,00±0,01 gram cocoa powder was measured in a 100 ml beaker; 15,0 ml tap water of minimal 50° C. was added to the cocoa powder; the solution was directly stirred until a homogeneous slurry was obtained; the contents of the 100 ml beaker were then cooled to room temperature by letting it rest for 15 minutes; the contents of the beaker were then stirred again and the slurry without lumps was poured into the optically neutral petri dish; the L, a and b-values were then measured on the calibrated color meter—the Hunter L value are recorded to 1 decimal, the a and b values to 2 decimals and the a/b value is calculated and recorded to 2 decimals. Note: after calibration of the color meter, the reference sample was measured first to check matrix fluctuations, followed by non-reference samples.

### Example 1

### Materials and Equipment

Deshelled West African cocoa nibs (shell <4%)
Tap water heated to 100° C.
Aluminum pans
Unox mindmaps oven (XEVC-0511 EPR)

### Methods

150 grams of West African nibs (standard fermented mixture of Cameroon and West Africa beans) were mixed with hot tap water in aluminum pans until all nibs were wet by visual inspection. The sample pans were then placed in a pre-heated Unox Mindmaps oven for 24 hours set at fan speed 1. The conditions are further described in Table 1, below.

Roasting and powder preparation. The resulting, processed nibs were recovered and directly processed into cocoa powder. They were roasted in a convection oven at 130° C. for 2 h. The nib moisture after drying was <2%. The roasted nibs were then ground into cocoa liquor and the butter was pressed out to leave cocoa cake, using conventional methods. The cocoa cake was ground into cocoa powder using a Retsch ZM-200 mill with a 0.5 mm sieve.

The color profiles of the obtained powders were measured using the colour measurement method described above, and are also provided in Table 1.

TABLE 1

| | Nib | | | | | | | | |
|---|---|---|---|---|---|---|---|---|---|
| | weight | Water | Temp. | Humidity | Time | L- | a- | b- | a/b- |
| Sample | (g) | (g) | (° C.) | (%) | (hours) | value | value | value | value |
| A | 150 | 60 | 75 | 100 | 24 | 18.76 | 11.25 | 9.68 | 1.16 |
| B | 150 | 45 | 75 | 100 | 24 | 18.57 | 11.33 | 9.62 | 1.18 |
| C | 150 | 75 | 75 | 100 | 24 | 18.84 | 11.21 | 9.64 | 1.16 |
| D | 150 | 45 | 85 | 100 | 24 | 16.28 | 10.23 | 8.07 | 1.27 |
| E | 150 | 75 | 85 | 100 | 24 | 16.49 | 10.64 | 8.35 | 1.27 |
| F | 150 | 60 | 85 | 100 | 24 | 15.98 | 10.31 | 8.08 | 1.28 |

Cocoa powder made with dry-steeped nibs have lower L-value than typical natural cocoa powder with L-value of 21.

### Example 2

### Materials and Equipment

Deshelled West African cocoa nibs (shell <4%)
Tap water heated to 100° C.
Slotted stainless steel trays
IKA conical mixer (CM10)
Unox mindmaps oven (XEVC-0511 EPR)

### Methods

Wet steeping. The IKA conical mixer was pre-heated to the 100° C. Two kilos of cocoa nibs (standard fermented mixture of Cameroon and West Africa beans) were added in the mixer and pre-heated for 30 minutes. 1200 g of hot tap water was then added. The reactor was sealed, and the stirrer turned on at 42 rpm. The process was run for 1 h at ambient pressure conditions. The nibs were divided into 2, half was directly dried and roasted while the rest were subjected to dry steeping.

Dry steeping. The wet steeped nibs were immediately placed on a slotted stainless-steel tray and placed in the pre-heated Unox Mindmaps oven for 5 days, at fan speed 1. Oven settings are detailed in Table 2, below.

Roasting and powder preparation. All nibs (wet steeped only and wet and dry steeped) were recovered and directly processed into cocoa powder. They were roasted in a convection oven at 130° C. for 2 h. The nib moisture after drying was <2%. The roasted nibs were then ground into cocoa liquor and the butter was pressed out to leave cocoa cake, using conventional methods. The cocoa cake was ground into cocoa powder using a Retsch ZM-200 mill with a 0.5 mm sieve.

The color profiles of the obtained powders were measured using the colour measurement method described above, and are also provided in Table 2.

TABLE 2

| | | Temper- | | Temper- | | | Moisture | Fat of | pH | | | | |
|---|---|---|---|---|---|---|---|---|---|---|---|---|---|
| | Water | ature | Time | ature | Humidity | Time | of powder | powder | of | | | | |
| | (g) | (° C.) | (h) | (° C.) | (%) | (days) | (%) | (%) | powder | L-value | a-value | b-value | a/b value |
| Sample | Wet Steep Step | | | Dry Steep Step | | | Results | | | | | | |
| A | 1200 | 100 | 1 | 70 | 100 | 5 | 3.2 | 10.1 | 5.42 | 16.6 | 10.5 | 8.5 | 1.24 |

| | | | | | | | | | | | |
|---|---|---|---|---|---|---|---|---|---|---|---|
| B | 1200 | 100 | 1 | No dry steep step | 3.91 | 8.22 | 5.68 | 20.3 | 10.3 | 9.6 | 1.06 |

Cocoa nibs which were subjected to a dry steep after wet steeping showed lower L-value and higher a/b-values than nibs which were directly roasted.

### Example 3

### Materials and Equipment

Deshelled West African cocoa nibs (shell <4%)
Tap water heated to 100° C.
Slotted stainless steel trays
IKA conical mixer (CM10)
Unox mindmaps oven (XEVC-0511 EPR)

### Methods

Wet steeping. The IKA conical mixer was pre-heated to the 130° C. 1500 grams of cocoa nibs (standard fermented mixture of Cameroon and West Africa beans) were added in the mixer and pre-heated for 30 minutes. 900 g of hot tap water was then added. The reactor was sealed, and the stirrer turned on at 42 rpm. Air of 6 L/min was blown through the reactor continuously throughout the process which was run for 1 h. Three batches of 300 g of the nibs were then prepared. One batch was directly dried and roasted while the other two were placed on separate trays and subjected to dry steeping.

Dry steeping. The wet steeped nibs were immediately placed on 2 slotted stainless-steel trays. The trays were placed in 2 different pre-heated Unox Mindmapsoven for different durations, but both at fan speed 1. Oven settings are detailed in Table 3 below.

Roasting and powder preparation. All nibs (wet steeped only and wet and dry steeped) were recovered and directly processed into cocoa powder. They were roasted in a convection oven at 130° C. for 2 h. The nib moisture after drying was <2%. The roasted nibs were then ground into cocoa liquor and the butter was pressed out to leave cocoa cake, using conventional methods. The cocoa cake was ground into cocoa powder using a Retsch ZM-200 mill with a 0.5 mm sieve.

The color profiles of the obtained powders were measured using the colour measurement method described above, and are also provided in Table 3.

TABLE 3

| | Wet steep | | | | | Dry steep | | | Results | | | | |
|---|---|---|---|---|---|---|---|---|---|---|---|---|---|
| | | | 45% | | Temper- | Temper- | | | pH | | | | |
| | Nibs | Water | w/v | Time | ature | ature | Humidity | Time | of | | | | a/b |
| Sample | (g) | (g) | KOH | (h) | (° C.) | (° C.) | (%) | (days) | powder | L-value | a-value | b-value | value |
| Ref | 1500 | 900 | 0 | 1 | 130 | No dry steep | | | 5.73 | 21.13 | 10.32 | 9.86 | 1.05 |
| A | 1500 | 900 | 0 | 1 | 130 | 70 | 100 | 1 | 5.64 | 19.06 | 10.96 | 9.69 | 1.13 |
| B | 1500 | 900 | 0 | 1 | 130 | 70 | 100 | 2 | 5.51 | 18.23 | 10.79 | 9.25 | 1.17 |
| C | 1500 | 900 | 0 | 1 | 130 | 70 | 100 | 5 | 5.46 | 16.59 | 10.17 | 8.22 | 1.24 |
| D | 1500 | 900 | 0 | 1 | 130 | 85 | 100 | 1 | 5.5 | 16.38 | 10.2 | 8.19 | 1.24 |
| E | 1500 | 900 | 0 | 1 | 130 | 85 | 100 | 2 | 5.33 | 14.74 | 9.45 | 7.21 | 1.31 |
| F | 1500 | 900 | 0 | 1 | 130 | 85 | 100 | 5 | 4.96 | 12.7 | 8.35 | 6.18 | 1.35 |

Cocoa nibs subjected to dry steeping after wet steeping showed progressively lower L-values the longer the dry steeping.

### Example 4

### Materials and Equipment

Deshelled West African cocoa nibs (shell <4%)
Tap water heated to 100° C.
Potassium hydroxide (45% w/v)
Slotted stainless steel trays
IKA conical mixer (CM10)
Unox mindmaps oven (XEVC-0511 EPR)

### Methods

Wet steeping. The IKA conical mixer was pre-heated to 100° C. 1500 grams of cocoa nibs (standard fermented mixture of Cameroon and West Africa beans) were added in the mixer and pre-heated for 30 minutes. 600 g of hot tap water and 55 g of KOH were then added. The reactor was sealed, and the stirrer turned on at 42 rpm. The process was run for 30 min then the heating jacket temperature was lowered to 80° C. The nibs were left in the mixer for another 30 min. The whole process was done under atmospheric pressure. Three batches of 300 g of the nibs were then prepared. One batch was directly dried and roasted while the other two were placed on separate trays and subjected to dry steeping.

Dry steeping. The wet steeped nibs were immediately placed on 2 slotted stainless-steel trays. The trays were placed in 2 different pre-heated Mindmaps Unox oven for different durations, but both at fan speed 1. Oven settings are found in Table 4 below.

Roasting and powder preparation. All nibs (wet steeped only and wet and dry steeped) were recovered and directly processed into cocoa powder. They were roasted in a convection oven at 130° C. for 2 h. The nib moisture after drying was <2%. The roasted nibs were then ground into cocoa liquor and the butter was pressed out to leave cocoa cake, using conventional methods. The cocoa cake was ground into cocoa powder using a Retsch ZM-200 mill with a 0.5 mm sieve.

The color profiles of the obtained powders were measured using the colour measurement method described above, and are also provided in Table 4.

TABLE 4

| | Wet steep | | | | | Dry steep | | | Results | | | | |
|---|---|---|---|---|---|---|---|---|---|---|---|---|---|
| | | | 45% | | Temper- | Temper- | | | pH | | | | |
| | Nibs | Water | w/v | Time | ature | ature | Humidity | Time | of | | | | a/b |
| Sample | (g) | (g) | KOH | (h) | (° C.) | (° C.) | (%) | (days) | powder | L-value | a-value | b-value | value |
| Ref. | 1500 | 600 | 55 | 1 | 100 | No dry steep | | | 6.77 | 17.16 | 10.08 | 8.29 | 1.22 |
| A | 1500 | 600 | 55 | 1 | 100 | 70 | 100 | 1 | 6.63 | 14.82 | 10.08 | 7.16 | 1.41 |
| B | 1500 | 600 | 55 | 1 | 100 | 70 | 100 | 2 | 6.42 | 14.25 | 9.35 | 6.69 | 1.4 |
| C | 1500 | 600 | 55 | 1 | 100 | 70 | 100 | 5 | 5.98 | 13.68 | 8.91 | 6.6 | 1.35 |
| D | 1500 | 600 | 55 | 1 | 100 | 85 | 100 | 1 | 6.43 | 13.18 | 8.81 | 6.15 | 1.43 |
| E | 1500 | 600 | 55 | 1 | 100 | 85 | 100 | 2 | 6.2 | 12.14 | 8.12 | 5.58 | 1.45 |
| F | 1500 | 600 | 55 | 1 | 100 | 85 | 100 | 5 | 5.78 | 11.08 | 7.13 | 5.12 | 1.39 |

Cocoa nibs treated with alkali during wet steeping showed progressive decrease in L-value as dry steeping time increased. This is a similar effect as seen with non-alkalized nibs.

### Example 5

### Materials and Equipment

Deshelled West African cocoa nibs (shell <4%)
Tap water heated to 100° C.
Slotted stainless steel trays
IKA conical mixer (CM10)
Unox mindmaps oven (XEVC-0511 EPR)

### Methods

Wet steeping. The IKA conical mixer was pre-heated to 100° C. 2000 grams of cocoa nibs (standard fermented mixture of Cameroon and West Africa beans) were added in the mixer and pre-heated for 30 minutes. 1200 g of hot tap water was then added to the nibs. The reactor was sealed and the stirrer turned on at 42 rpm. The reactor was put under air pressure of 3 bars continuously throughout the process which was run for 1 h. The nibs were then subjected to dry steeping.

Dry steeping. The wet steeped nibs from the previous step were immediately placed on a slotted stainless-steel tray. The tray was placed in a Unox Mindmaps oven, pre-heated to 70° C., at fan speed 1 and 100% humidity, for 5 days.

Roasting and powder preparation. Processed nibs were roasted in a convection oven at 130° C. for 2 h. The nib moisture after drying was <2%. The roasted nibs were then ground into cocoa liquor and the butter was pressed out to leave cocoa cake, using conventional methods. The cocoa cake was ground into cocoa powder using a Retsch ZM-200 mill with a 0.5 mm sieve.

The obtained powders were then analyzed for and the results are provided in Table 5.

TABLE 5

| | Moisture | | | | | | |
|---|---|---|---|---|---|---|---|
| | of | Fat of | | | | | |
| | powder | powder | | | | | |
| Sam- | (% by | (% by | pH of | L- | a- | | |
| ple | weight) | weight) | powder | value | value | b-value | a/b value |
| A | 4.2 | 7.67 | 5.43 | 16.4 | 10.1 | 8.2 | 1.2 |

### Example 6

### Materials and Equipment

Deshelled West African cocoa nibs (shell <4%)
Deshelled Ivory coast cocoa nibs (shell <4%)
Tap water heated to 100° C.
Slotted stainless steel trays
IKA conical mixer (CM10)
Unox mindmaps oven (XEVC-0511 EPR)

### Methods

Wet steeping. Two IKA conical mixers were pre-heated to 115° C. One mixer was filled with 2000 g of standard fermented mixture of Cameroon and West Africa cocoa nibs and pre-heated for 30 minutes. The other was filled with 2000 g of standard fermented Ivory coast cocoa nibs and also preheated for 30 minutes. 1200 g of hot tap water was then added to each mixer. The reactors were sealed and the stirrers turned on at 42 rpm. The reactors were kept at 115° C., and put under air pressure of 1.5 bar while air of 3 L/min was blown through them continuously throughout the process which was run for 3 h. Then, the nibs were recovered and subjected to dry steeping.

Dry steeping. Each batch of wet steeped nibs was immediately placed on a slotted stainless-steel tray. Each tray was placed in a Unox Mindmaps ovens, pre-heated to 70° C., at fan speed 1 and 100% humidity, for 5 days.

Roasting and powder preparation. The processed nibs were roasted in a convection oven at 130° C. for 2 h. The nib moisture after drying was <2%. The roasted nibs were then ground into cocoa liquor and the butter was pressed out to leave cocoa cake, using conventional methods. The cocoa cake was ground into cocoa powder using a Retsch ZM-200 mill with a 0.5 mm sieve. The resulting powders were analyzed and the results are provided in Table 6 below.

TABLE 6

| | | Moisture | Fat of | | | | | |
|---|---|---|---|---|---|---|---|---|
| | | of | powder | | | | | |
| | | powder | (% | | | | | |
| Sam- | Nib | (% by | by | pH of | L- | a- | b- | a/b |
| ple | type | weight) | weight) | powder | value | value | value | value |
| E | West | 3.73 | 8.5 | 5.45 | 14.44 | 8.78 | 6.93 | 1.27 |
| | African | | | | | | | |
| | mix | | | | | | | |
| I | Ivory | 2.63 | 8.11 | 5.4 | 13.21 | 7.81 | 6.21 | 1.26 |
| | coast | | | | | | | |

### Example 7

A quantitative descriptive analysis (QDA) was conducted by an expert panel to determine the sensory properties of cocoa powders of the present invention, compared to commercially available cocoa powders (all of which had similar colour profiles). The expert panel was previously trained on the category of cocoa powders. The selected panelists evaluated the sample set blind, in triplicate, using a monadic sequential design and with a balanced randomized order. The sample set was composed of:
4 commercial cocoa powders: Competitor sample A (DDP 10-12 cocoa powder from Barry Callebaut); Competitor sample B (D11S cocoa powder from Olam); Cargill sample C (10-12% GT78 from Cargill), and Cargill sample D (10-12% DP70 from Cargill),
3 cocoa powders of the present invention: Pure 2.0 A (corresponding to sample A from Example 5), Pure 2.0 E and Pure 2.0 I (corresponding, respectively, to samples E and I from Example 6)

For each sample, 24 g of cocoa powder was mixed with 60 g of fine crystalline sugar (from Van Gilse) and 120 g of semi-skimmed milk powder (from Bestway Ingredients). The resulting 204 g blend was then mixed with 1 L of warm tap water until a homogeneous mixture was obtained, and the sugar had fully dissolved.

Each sample was analyzed three times. Details of the analysis are as follows:
Number of panelists: Repetition 1: 11/12; Repetition 2: 12; Repetition 3: 9/11
Serving Procedure:
   Sample presentation: Balanced Randomized with 3-digit codes
   Quantity served: 1 plastic cup of ˜5 ml
   Serving condition: 50° C.
   Monadic Sequential: 3 samples per session.
Testing Protocol:
   Samples were swallowed
   Break of 2 minutes between samples
   Panelists scored and evaluated the sensory attribute(s) individually
   The following attributes were assessed: sweet, sour, bitter, roasted, milk, cocoa, chocolate, alkali, and astringent
   A numerical intensity score of 0-100 was assigned (where 0 corresponds to the absence of the attribute, while 100 corresponds to the upper bound extreme occurrence of the attribute)
Data collection: EyeQuestion (https://eyequestion.nl/)

### Results

Pure 2.0—A:

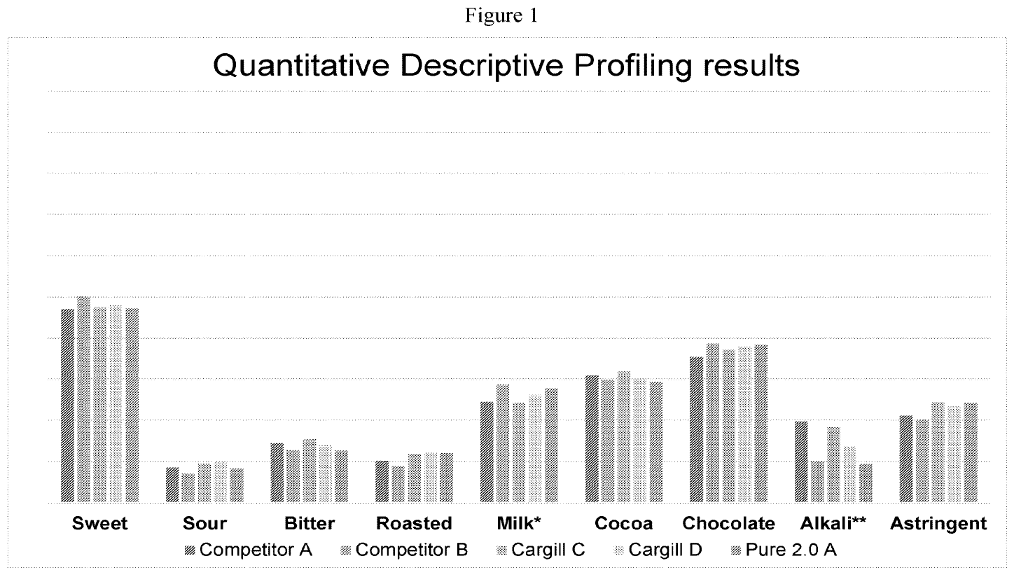

Sample Pure 2.0 A was perceived as having a very similar sensory profile to the four commercial samples. Indeed, the results indicated no significant differences (p>0.05) on sweetness, bitterness, cocoa, chocolate and roasted notes. Two significant differences were found, where Pure 2.0 A scored significantly higher in milk (p<0.1) compared to Cargill sample C and was rated significantly lower in alkali (p<0.05) compared to Competitor sample A. Detailed results are shown in FIG. 1.
Pure 2.0—E:

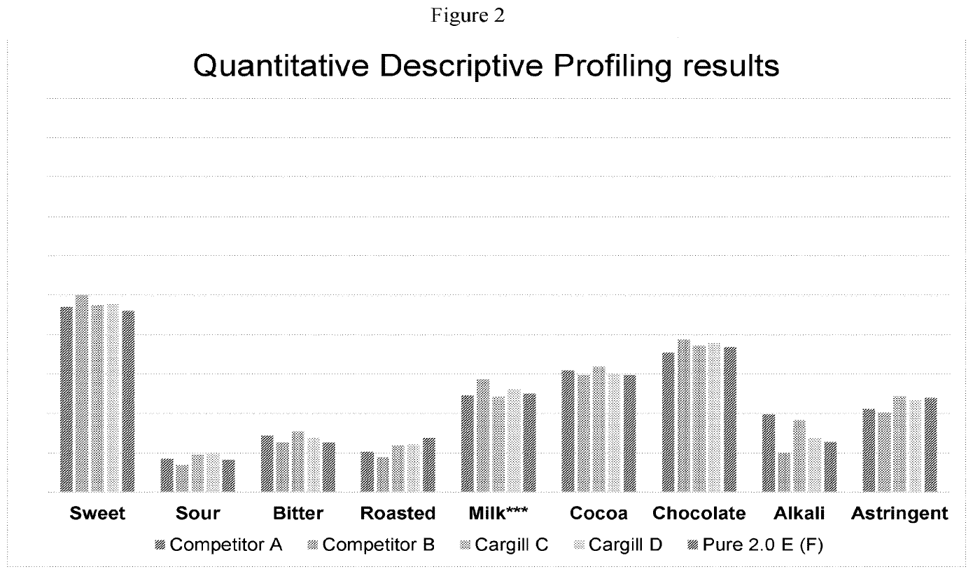

Sample Pure 2.0 E shared similar sensory properties with the commercial samples. Indeed, the results have shown no significant differences (p>0.05) on a number of attributes like sweetness, bitterness, cocoa, chocolate and roasted notes when compared to the remaining samples. However, the prototype was perceived as being significantly less milky (p<0.1) versus Competitor sample B. There was also a trend for this sample to be less alkali compared to Competitor sample A and Cargill sample C. Detailed results are shown in FIG. 2.
Pure 2.0—I:

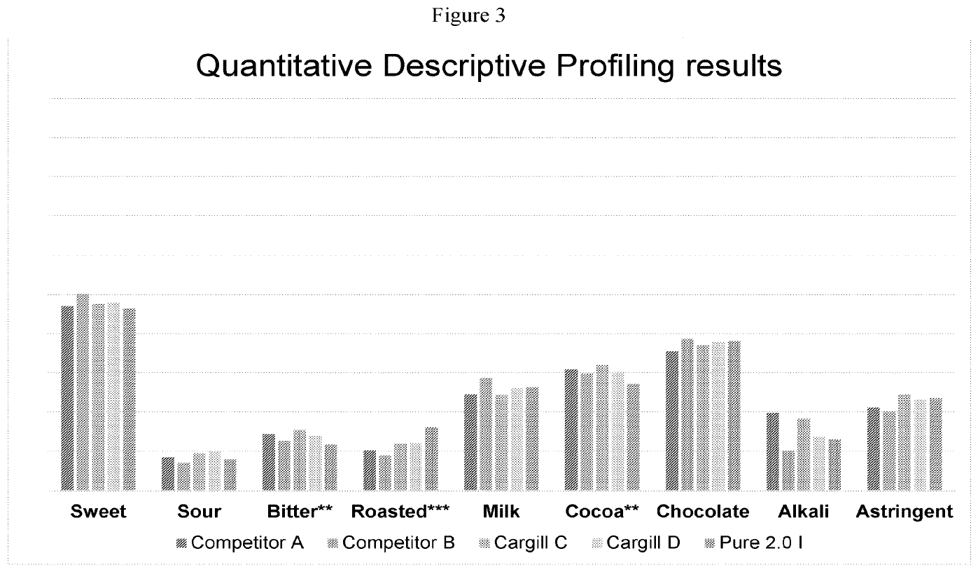

The trained panel indicated that sample Pure 2.0 I had significantly more roasted notes compared to Competitor sample A (p<0.05) and Competitor sample B (p<0.01) and less cocoa notes than Competitor sample A (p<0.1). Compared to Cargill sample C, Pure 2.0 I was found to have significantly less cocoa and bitter notes (p<0.05). There was also a trend for this sample to be less alkali compared to Competitor sample A and Cargill sample C. No significant differences (p>0.05) were detected on attributes like milk, sweet and chocolate. Detailed results are shown in FIG. 3.

1. A process for producing a dark cocoa product, comprising the steps of:
a. wetting a cocoa material;
b. dry steeping the wetted cocoa material in the presence of oxygen, wherein the dry steeping does not include the addition of alkali or an alkali solution; and
c. recovering a dark cocoa product.

2. A process according to claim 1 wherein the cocoa material of step (a) is selected from cocoa beans, cocoa nibs, cocoa liquor, cocoa cake, cocoa powder, and mixtures of any two or more thereof.

3. A process according to claim 1, wherein the dry steeping step:
is performed in an oxygen-rich atmosphere; and/or
includes oxygenating the wetted cocoa material of step (a).

4. A process according to claim 3, wherein oxygenating the wetted cocoa material comprises:
contacting the wetted cocoa material with an oxygen-rich gas flow; and/or
contacting the wetted cocoa material with an oxidizing agent.

5. A process according to claim 1, wherein the dry steeping step is performed at a temperature of between 30 and 120° C.

6. A process according to claim 1, wherein the dry steeping step is performed at a relative humidity above 50%.

7. A process according to claim 1, wherein the wetted cocoa material has a moisture content of 10-60% by weight.

8. A process according to claim 7, wherein the moisture content of the wetted cocoa material is maintained during step (b).

9. A process according to claim 1, wherein dry steeping the wetted cocoa material in step (b) comprises holding the wetted cocoa material at an elevated temperature for at least 12 hours or at least 24 hours or at least 24 hours to 6 days.

10. A process according to claim 1, further comprising one or more wet steeping steps.

11. A process according to claim 1, wherein step (a) comprises wet steeping the cocoa material.

12. A process according to claim 1, where step (c) comprises drying and optionally milling the dry steeped cocoa material.

13. A dark cocoa product obtained by, or obtainable by, the process of claim 1.

14. A dark cocoa product according to claim 13 which has:
an L value below 20;
a ratio of a/b values greater than 1; and/or
a pH below 9.0.

15. A dark cocoa product according to claim 13 having an ash content of less than 10% on fat-free dry matter (FFDM), preferably of less than 9% FFDM, more preferably of less than 8% FFDM.

16. A dark cocoa product according to claim 13, which is a natural cocoa product.
